(19) United States
(12) Patent Application Publication
(10) Pub. No.: US 2024/0274984 A1
(43) Pub. Date: Aug. 15, 2024

(54) ELASTOMERIC CUSHION LAYER FOR SILICON-BASED SOLID-STATE BATTERY

(71) Applicant: GM GLOBAL TECHNOLOGY OPERATIONS LLC, Detroit, MI (US)

(72) Inventors: Zhe Li, Shanghai (CN); Qili Su, Shanghai (CN); Dave G. Rich, Sterling Heights, MI (US); Yong Lu, Shanghai (CN); Haijing Liu, Shanghai (CN)

(21) Appl. No.: 18/360,065

(22) Filed: Jul. 27, 2023

(30) Foreign Application Priority Data
Feb. 14, 2023 (CN) 202310114228.2

(51) Int. Cl. H01M 50/494; H01M 4/62; H01M 10/0525; H01M 10/0562; H01M 50/451

(52) U.S. Cl. CPC H01M 50/494; H01M 4/623; H01M 4/625; H01M 10/0525; H01M 10/0562; H01M 50/451; H01M 2300/008

(57) ABSTRACT

A battery cell including an anode electrode layer including an anode active material. A cathode electrode layer comprises cathode active material. A solid electrolyte layer is arranged between the anode electrode layer and the cathode electrode layer. An elastomeric layer is arranged between the anode electrode layer and the solid electrolyte layer.

### CROSS-REFERENCE TO RELATED APPLICATIONS

This application claims the benefit of Chinese Patent Application No. 202310114228.2, filed on Feb. 14, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to silicon-based solid-state batteries.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and discharging of the battery system during charging and/or driving. Manufacturers of EVs are pursuing increased energy density to increase the range of the EVs.

Solid-state batteries (SSBs) with solid electrolyte and SSBs with sulfide electrolyte have the potential to be superior to various different types of lithium-ion batteries (LIBs) in terms of abuse tolerance, working temperature range, and system design.

### SUMMARY

A battery cell including an anode electrode layer including an anode active material. A cathode electrode layer comprises cathode active material. A solid electrolyte layer is arranged between the anode electrode layer and the cathode electrode layer. An elastomeric layer is arranged between the anode electrode layer and the solid electrolyte layer.

In some examples, the elastomeric layer comprises an elastomer matrix and a lithium-ion conducting medium. The elastomer matrix includes one or more materials selected from a group consisting of an acrylic-based elastomer, natural rubber, polyisoprene, butyl rubber, chloroprene, ethylene propylene diene, fluorosilicone, nitrile butadiene, saturated nitrile rubber, silicone rubber, styrene butadiene rubber, and urethane. The lithium-ion conducting medium comprises at least one of a lithium salt and a solid electrolyte.

In other features, the lithium salt comprises a lithium cation and at least one anion selected from a group consisting of hexafluoroarsenate, hexafluorophosphate, perchlorate, tetrafluoroborate, vis(oxalate)borate (BOB), bis(fluorosulfonyl)imide (FSI), bis(trifluoromethanesulfonyl)imide (TFSI), cyclo-difluoromethane-1,1-bis(sulfonyl)imide (DMSI), bis(perfluoroethanesulfonyl)imide (BETI), difluoro(oxalato)borate (DFOB), and bis(fluoromalonato)borate (BFMB).

In other features, the solid electrolyte includes one or more materials selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte. The elastomeric layer further comprises a plasticizer. The plasticizer is selected from a group consisting of an ether, a nitrile, a carbonate solvent, a lactone, a sulfone, a phosphate, and an ionic liquid.

In other features, the anode electrode layer comprises an anode active material, a solid electrolyte, and a binder comprising an elastomer matrix and a lithium-ion conducting medium. The binder further comprises a plasticizer. The elastomeric layer comprises an elastomer matrix and a lithium-ion conducting medium. The anode electrode layer comprises the anode active material, a solid electrolyte, and a binder comprising an elastomer matrix and a lithium-ion conducting medium.

In other features, the cathode electrode layer comprises a cathode active material, a solid electrolyte, a conductive additive, and a binder. The cathode active material includes one or more materials selected from a group consisting of rock salt layered oxides, spinel, polyanion cathode materials, lithium transition-metal oxides, and lithiated metal oxide/sulfide. The anode active material includes one or more materials selected from a group consisting of silicon, silicon mixed with graphite, Li4Ti5O12, a transition-metal, a Li metal, and a Li alloy.

In other features, the conductive additive is selected from a group consisting of carbon black, graphite, graphene, graphene oxide, Super P, acetylene black, carbon nanofibers, and carbon nanotubes. The binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

A battery cell includes an anode electrode layer including anode active material comprising anode active material, a solid electrolyte, and a binder comprising an elastomer matrix and a lithium-ion conducting medium. A cathode electrode layer comprises cathode active material. A solid electrolyte layer is arranged between the anode electrode layer and the cathode electrode layer.

In other features, the binder further comprises a plasticizer. The elastomer matrix includes one or more materials selected from a group consisting of an acrylic-based elastomer, natural rubber, polyisoprene, butyl rubber, chloroprene, ethylene propylene diene, fluorosilicone, nitrile butadiene, saturated nitrile rubber, silicone rubber, styrene butadiene rubber, and urethane. The lithium-ion conducting medium comprises at least one of a lithium salt and a solid electrolyte. The lithium salt comprises a lithium cation and at least one anion selected from a group consisting of hexafluoroarsenate, hexafluorophosphate, perchlorate, tetrafluoroborate, vis(oxalate)borate (BOB), bis(fluorosulfonyl)imide (FSI), bis(trifluoromethanesulfonyl)imide (TFSI), cyclo-difluoromethane-1,1-bis(sulfonyl)imide (DMSI), bis(perfluoroethanesulfonyl)imide (BETI), difluoro(oxalato)borate (DFOB), and bis(fluoromalonato)borate (BFMB). The solid electrolyte includes one or more materials selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte.

In other features, the plasticizer is selected from a group consisting of an ether, a nitrile, a carbonate solvent, a lactone, a sulfone, a phosphate, and an ionic liquid.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A and 1B are side cross-sectional views of a silicon-based solid-state battery including an elastomeric layer arranged adjacent to the anode electrode and including an elastomeric material and lithium-ion conducting material in discharged and charged states according to the present disclosure;

FIGS. 2A and 2B illustrate an elastomeric layer including an elastomeric material and lithium-ion conducting material in discharged and charged states of silicon-based solid-state battery according to the present disclosure;

FIG. 3 is a side cross-sectional view of a silicon-based solid-state battery including an anode electrode comprising a binder including an elastomeric material and lithium-ion conducting material according to the present disclosure;

FIG. 4 is a side cross-sectional view of a silicon-based solid-state battery including an elastomeric layer and an anode electrode including a binder comprising an elastomeric material and lithium-ion conducting material according to the present disclosure;

FIG. 5A is a side cross-sectional view of a silicon-based solid-state battery including an elastomeric layer including lithium-ion conducting material and a plasticizer according to the present disclosure;

FIG. 5B is a side cross-sectional view of the elastomeric layer including lithium-ion conducting material and a plasticizer according to the present disclosure;

FIG. 6 is a side cross-sectional view of a silicon-based solid-state battery including an anode electrode including a binder comprising an elastomeric material, a lithium-ion conducting material, and a plasticizer according to the present disclosure; and

FIG. 7 is a side cross-sectional view of a silicon-based solid-state battery including an elastomeric material including a plasticizer and an anode electrode including a binder with an elastomeric material, a lithium-ion conducting material, and a plasticizer according to the present disclosure.

In the drawings, reference numbers may be reused to identify similar and/or identical elements.

### DETAILED DESCRIPTION

While the battery cells are described herein in the context of electric vehicles (EVs), the battery cells can be used in stationary applications, non-vehicle applications, and/or in other applications.

Silicon has emerged as a promising alternative to graphite-based anode electrodes for solid-state batteries because it is environmentally benign, has reasonable electrochemical potential (˜0.3 Volts vs Li/Li+), and a high theoretical capacity (4200 milliamp hours per gram (mAh/g) for Li4.4Si). However, Si anode electrodes may suffer from volumetric expansion (e.g., >300%) during charging. The significant volume expansion and shrinkage creates mechanical stresses, which may cause cracking and/or pulverization of Si and may deteriorate ionic interfaces between the solid electrolyte layer and the Si anode electrode layer. As a result, the battery capacity may decay.

An elastomeric layer according to the present disclosure includes an elastomer matrix and a lithium (Li)-ion conducting medium. For example, the elastomer matrix comprises poly-butyl acrylate (PBA) cross-linked by poly(ethylene glycol) diacrylate (PEGDA)) and the Li-ion conducting medium includes LiTFSI (bis(trifluoromethane)solfonimide). The elastomeric layer is arranged between a solid electrolyte layer and a silicon (Si) anode electrode layer in a solid-state battery (SSB).

The mechanical elasticity of the elastomeric layer helps to release stress generated during charging and discharging. In other words, the elastomeric layer accommodates volume change of the Si active material and minimizes possible structural changes in the Si anode electrode layer. Adhesion properties of the elastomeric layer may maintain interfacial ionic contact between the solid electrolyte layer and the Si anode electrode layer.

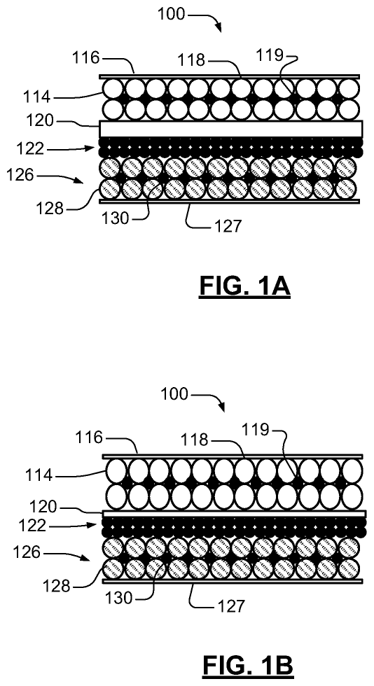

Referring now to FIGS. 1A to 1B, a silicon-based solid-state battery 100 includes an elastomeric layer 120 arranged adjacent to an anode electrode layer 114. In FIG. 1A, a solid electrolyte layer 122 is arranged between the elastomeric layer 120 and a cathode electrode layer 126. The anode electrode layer 114 includes anode active material 118, solid electrolyte 119, and an anode current collector 116. The cathode electrode layer 126 includes cathode active material 128, solid electrolyte 130, and a cathode current collector 127.

In FIG. 1A, the silicon-based solid-state battery 100 is shown in a discharged state. In FIG. 1B, the silicon-based solid-state battery 100 is shown in a charged state. Charging causes the anode active material 118 to expand into the elastomeric layer 120 causing the elastomeric layer 120 to be compressed to absorb or cushion the expansion of the anode active material 118.

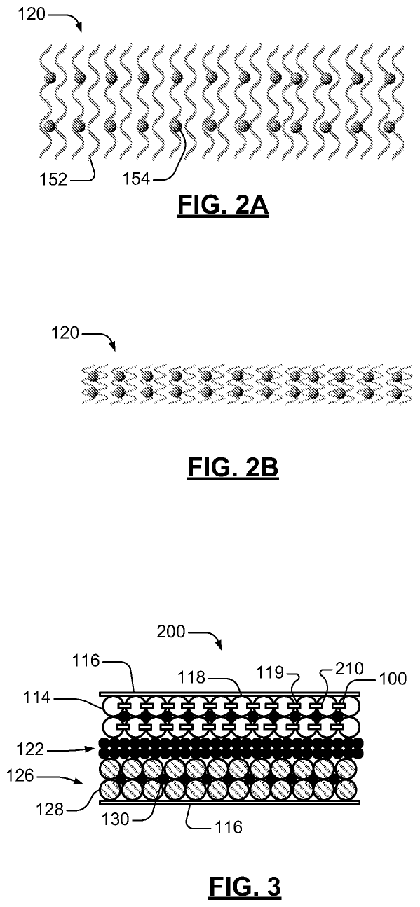

In FIGS. 2A and 2B, the elastomeric layer 120 includes the elastomeric matrix 152 and the lithium-ion conducting medium 154 shown in discharged and charged states, respectively.

In some examples, the elastomer matrix comprises poly(butyl acrylate) (PBA) cross-linked by 1 mol % poly(ethylene glycol) diacrylate (PEGDA). In some examples, an average molecular weight (MW) is in a range from approximately 1000 to approximately 999,000 (e.g., 99,000). In some examples, the elastomer matrix has a density ρ in a range from approximately 0.90 to approximately 1.50 (e.g., 1.09 gras per milliliter (g/mL) at 25° C.). In some examples, the Li-ion conducting medium comprises a lithium salt such as LiTFSI in a range from approximately 0.01 M to approximately 5M (e.g., 0.8M).

Referring now to FIG. 3, the elastomeric material can be arranged in other locations and cushion the expansion of the silicon during the charging/discharging. In FIG. 3, a silicon-based solid-state battery 200 includes the anode electrode layer 114, the solid electrolyte layer 122, and the cathode electrode layer 126. The anode electrode layer 114 includes the anode active material 118, the solid electrolyte 119, and a binder 210 comprising the elastomeric material and the lithium-ion conducting material.

Referring now to FIG. 4, a silicon-based solid-state battery 300 includes the elastomeric layer 120 and the anode electrode layer 114 including the binder 210 with the elastomeric material and the lithium-ion conducting material.

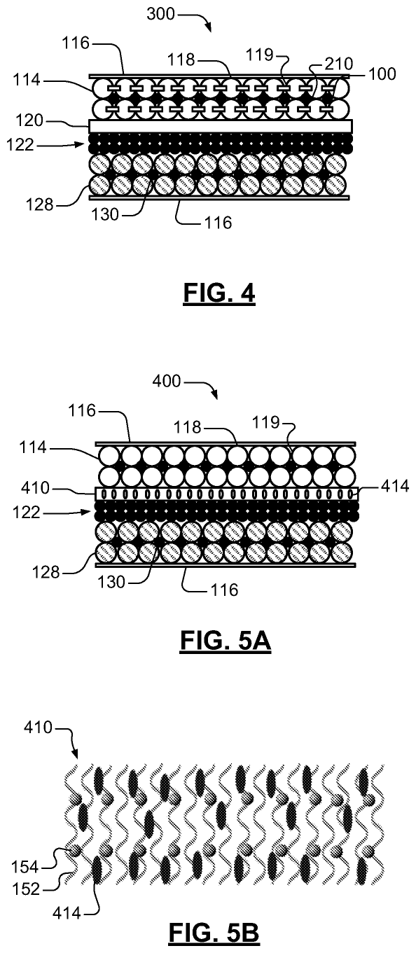

In other examples, the elastomeric layer and/or the elastomeric material in the binder includes plasticizer. Referring now to FIGS. 5A and 5B, a silicon-based solid-state battery 400 includes an elastomeric layer 410 that includes the elastomeric matrix 152, the lithium-ion conducting medium 154, and a plasticizer 414. In some examples, the plasticizer 414 provides approximately 5 wt % to approximately 50 wt % (e.g., approximately 10 wt %) of the elastomeric layer 410.

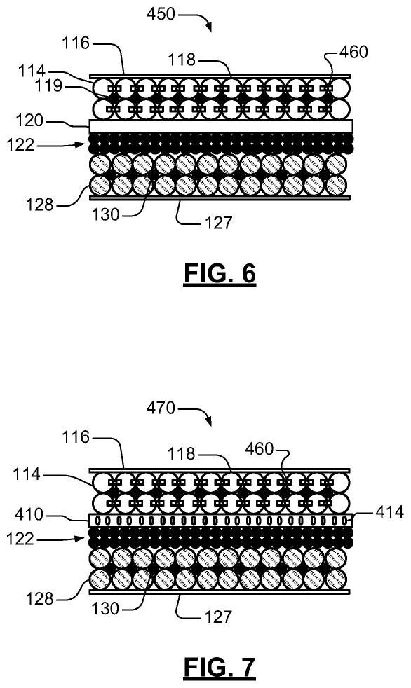

Referring now to FIG. 6, the anode electrode layer 114 of the silicon-based solid-state battery 450 includes the anode active material 118, the solid electrolyte 119, a binder 460. The binder 460 includes the elastomeric matrix 152, the lithium-ion conducting medium 154, and the plasticizer 414.

Referring now to FIG. 7, a silicon-based solid-state battery 470 includes the elastomeric layer 410. The anode electrode layer 114 of the silicon-based solid-state battery 470 includes the anode active material 118, the solid electrolyte 119, and the binder 460.

In some examples, the Li-ion conducting medium is compatible and dispersible within an elastomer matrix. In some examples, the Li-ion conducting medium includes at least one of a lithium salt and a solid electrolyte. In some examples, the lithium salt includes a lithium cation and at least one anion selected from a group including or consisting of hexafluoroarsenate, hexafluorophosphate, perchlorate, tetrafluoroborate, vis(oxalate)borate (BOB), bis(fluorosulfonyl)imide (FSI), bis(trifluoromethanesulfonyl)imide (TFSI), cyclo-difluoromethane-1,1-bis(sulfonyl)imide (DMSI), bis(perfluoroethanesulfonyl)imide (BETI), difluoro(oxalato)borate (DFOB), and bis(fluoromalonato)borate (BFMB).

In some examples, the solid electrolyte includes one or more materials selected from a group including or consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte.

Examples of oxide-based solid electrolyte include garnet type (e.g., Li₇La₃Zr₂O₁₂). Perovskite type (e.g., Li₃ₓLa_{2/3-x}TiO₃), NASICON type (e.g., Li_{1.4}Al_{0.4}Ti_{1.6}(PO₄)₃and Li₁₊ₓAlₓGe₂₋ₓ(PO₄)₃), and LISICON type (e.g., Li₂₊₂ₓZn₁₋ₓGeO₄). Examples of metal-doped or aliovalent-substituted oxide solid electrolyte include Al (or Nb)-doped Li₇La₃Zr₂O₁₂, Sb-doped Li₇La₃Zr₂O₁₂ , Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂.

In some examples, the sulfide electrolyte is selected from a group including or consisting of pseudobinary sulfide, pseudoternary sulfide, and pseudoquarternary sulfide. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system. Examples of pseudoternary sulfide. e.g., Li₂O—Li₂S—P₂S₅ system, Li₂S—P₂S₅₋P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI.0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

Examples of nitride-based solid electrolyte include Li₃N, Li₇PN₄, and LiSi₂N₃. Examples of hydride-based solid electrolyte include LiBH₄, LiBH₄—LiX (X=Cl, Br or I), LiNH₂, Li₂NH, LiBH₄—LiNH₂, and Li₃AlH₆. Examples of halide-based solid electrolyte include LiI, Li₃InCl₆, Li₂CdCl₄, Li₂MgCl₄, Li₂CdI₄, Li₂ZnI₄, and Li₃Ocl. Examples of borate-based solid electrolyte include Li₂B₄O₇ and Li₂O—B₂O₃—P₂O₅

In some examples, the elastomer matrix disperses the Li-ion conducting medium while maintaining both mechanical elasticity and functionality. In some examples, the elastomer matrix includes one or more materials selected from a group including or consisting of acrylic-based elastomers (e.g., poly(butyl acrylate), poly(n-butyl acrylate)-g-polyacrylonitrile), natural rubber, polyisoprene, butyl rubber, chloroprene, ethylene propylene diene, fluorosilicone, nitrile butadiene, saturated nitrile rubber, silicone rubber, styrene butadiene rubber, and urethane (e.g., polyurethane).

In some examples, the anode and cathode electrodes include electrode active material, solid electrolyte, conductive additive, and binder. In some examples, the anode and cathode electrodes have a thickness in a range from approximately 1 micrometers (μm) to approximately 400 μm. In some examples, the electrode active material includes approximately 30 wt % to 98 wt %, the solid electrolyte includes approximately 0 wt % to 50 wt %, the conductive additive includes approximately 0 wt % to 30 wt %, and the binder includes 0.1 wt % to 20 wt %. In various implementations, a sum of the wt % of the electrode active material, the solid electrolyte, the conductive additive, and the binder may be 100 wt %.

In some examples, the cathode active material includes one or more materials selected from a group including or consisting of rock salt layered oxides, spinel, polyanion cathode materials, lithium transition-metal oxides, and lithiated metal oxide/sulfide. In some examples, surface-coated or doped rock salt layered oxides, spinel, polyanion cathode materials, and lithium transition-metal oxides are used.

Examples of rock salt layered oxides include LiCoO₂, LiNiₓMn_{y}Co_{1-x-y}O₂, LiNiₓMn_{y}Al_{1-x-y}O2, LiNiₓMn₁₋ₓO₂, Li₁₊ₓMO₂. Examples of spinel includes LiMn₂O₄, and LiNi_{0.5}Mn_{1.5}O₄. Examples of polyanion cathode include LiV₂(PO₄)₃. Examples of surface-coated and/or doped cathode materials include LiNbO₃-coated LiMn₂O₄, and Al-doped LiMn₂O₄. Examples of lithiated metal oxide/sulfide LiTiS₂, lithium sulfide, and sulfur.

In some examples, the anode active materials include one or more materials selected from a group consisting of silicon, silicon mixed with graphite, Li₄Ti₅O₁₂, transition-metal (e.g., Sn), Li metal and Li alloy.

In some examples, the binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

In some examples, the conductive additive is selected from a group consisting of carbon black, graphite, graphene, graphene oxide, Super P, acetylene black, carbon nanofibers, carbon nanotubes and other electronically conductive additives.

In some examples, the plasticizer is selected from a group including or consisting of an ether, a nitrile, a carbonate solvent, a lactone, a sulfone, a phosphate, and an ionic liquid.

Examples of ethers include triethylene glycol dimethylether (triglyme, G3), tetraethylene glycol dimethylether (tetraglyme, G4), 1,3-dimethoxy propane and 1,4-dioxane. Examples of nitriles include succinonitrile, glutaronitrile and adiponitrile. Examples of carbonate solvents include ethylene carbonate (EC), propylene carbonate (PC), glycerol carbonate, vinylene carbonate, fluoroethylene carbonate and 1,2-Butylene carbonate. Examples of lactones include γ-butyrolactone and δ-valerolactone. Examples of sulfones include tetramethylene sulfone, ethyl methyl sulfone, vinyl sulfone, phenyl sulfone, 4-fluorophenyl sulfone and benzyl sulfone. Examples of phosphates include triethyl phosphate and trimethyl phosphate.

Examples of ionic liquids include ionic liquid cations and ionic liquid anions. Examples of ionic liquid cations include 1-Ethyl-3-methylimidazolium, 1-Propyl-1-methylpiperidinium, 1-Butyl-1-methylpiperidinium, 1-Methyl-1-ethylpyrrolidinium, 1-Propyl-1-methylpyrrolidinium, 1-Butyl-1-methylpyrrolidinium. Examples of ionic liquid anions include bis(fluorosulfonyl)imide (FSI) and bis(trifluoromethanesulfonyl)imide (TFSI).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

1. A battery cell comprising:
an anode electrode layer including an anode active material;
a cathode electrode layer comprising cathode active material;
a solid electrolyte layer arranged between the anode electrode layer and the cathode electrode layer; and
an elastomeric layer arranged between the anode electrode layer and the solid electrolyte layer.

2. The battery cell of claim 1, wherein the elastomeric layer comprises an elastomer matrix and a lithium-ion conducting medium.

3. The battery cell of claim 2, wherein the elastomer matrix includes one or more materials selected from a group consisting of an acrylic-based elastomer, natural rubber, polyisoprene, butyl rubber, chloroprene, ethylene propylene diene, fluorosilicone, nitrile butadiene, saturated nitrile rubber, silicone rubber, styrene butadiene rubber, and urethane.

4. The battery cell of claim 2, wherein the lithium-ion conducting medium comprises at least one of a lithium salt and a solid electrolyte.

5. The battery cell of claim 4, wherein the lithium salt comprises a lithium cation and at least one anion selected from a group consisting of hexafluoroarsenate, hexafluorophosphate, perchlorate, tetrafluoroborate, vis(oxalate)borate (BOB), bis(fluorosulfonyl)imide (FSI), bis(trifluoromethanesulfonyl)imide (TFSI), cyclo-difluoromethane-1,1-bis(sulfonyl)imide (DMSI), bis(perfluoroethanesulfonyl)imide (BETI), difluoro(oxalato)borate (DFOB), and bis(fluoromalonato)borate (BFMB).

6. The battery cell of claim 4, wherein the solid electrolyte includes one or more materials selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte.

7. The battery cell of claim 2, wherein the elastomeric layer further comprises a plasticizer.

8. The battery cell of claim 7, wherein the plasticizer is selected from a group consisting of an ether, a nitrile, a carbonate solvent, a lactone, a sulfone, a phosphate, and an ionic liquid.

9. The battery cell of claim 1, wherein the anode electrode layer comprises an anode active material, a solid electrolyte, and a binder comprising an elastomer matrix and a lithium-ion conducting medium.

10. The battery cell of claim 9, wherein the binder further comprises a plasticizer.

11. The battery cell of claim 1, wherein:
the elastomeric layer comprises an elastomer matrix and a lithium-ion conducting medium; and
the anode electrode layer comprises the anode active material, a solid electrolyte, and a binder comprising an elastomer matrix and a lithium-ion conducting medium.

12. The battery cell of claim 1, wherein the cathode electrode layer comprises a cathode active material, a solid electrolyte, a conductive additive, and a binder.

13. The battery cell of claim 12, wherein the cathode active material includes one or more materials selected from a group consisting of rock salt layered oxides, spinel, polyanion cathode materials, lithium transition-metal oxides, and lithiated metal oxide/sulfide.

14. The battery cell of claim 11, wherein the anode active material includes one or more materials selected from a group consisting of silicon, silicon mixed with graphite, Li₄Ti₅O₁₂, a transition-metal, a Li metal, and a Li alloy.

15. The battery cell of claim 12, wherein the conductive additive is selected from a group consisting of carbon black, graphite, graphene, graphene oxide, Super P, acetylene black, carbon nanofibers, and carbon nanotubes.

16. The battery cell of claim 12, wherein the binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

17. A battery cell comprising:
an anode electrode layer including anode active material comprising anode active material, a solid electrolyte, and a binder comprising an elastomer matrix and a lithium-ion conducting medium;
a cathode electrode layer comprising cathode active material; and
a solid electrolyte layer arranged between the anode electrode layer and the cathode electrode layer.

18. The battery cell of claim 17, wherein the binder further comprises a plasticizer.

19. The battery cell of claim 17, wherein:
the elastomer matrix includes one or more materials selected from a group consisting of an acrylic-based elastomer, natural rubber, polyisoprene, butyl rubber, chloroprene, ethylene propylene diene, fluorosilicone, nitrile butadiene, saturated nitrile rubber, silicone rubber, styrene butadiene rubber, and urethane;
the lithium-ion conducting medium comprises at least one of a lithium salt and a solid electrolyte;
the lithium salt comprises a lithium cation and at least one anion selected from a group consisting of hexafluoroarsenate, hexafluorophosphate, perchlorate, tetrafluoroborate, vis(oxalate)borate (BOB), bis(fluorosulfonyl)imide (FSI), bis(trifluoromethanesulfonyl)imide (TFSI), cyclo-difluoromethane-1,1-bis(sulfonyl)imide (DMSI), bis(perfluoroethanesulfonyl)imide (BETI), difluoro(oxalato)borate (DFOB), and bis(fluoromalonato)borate (BFMB); and
the solid electrolyte includes one or more materials selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and borate-based solid electrolyte.

20. The battery cell of claim 18, wherein the plasticizer is selected from a group consisting of an ether, a nitrile, a carbonate solvent, a lactone, a sulfone, a phosphate, and an ionic liquid.
